(19) United States
(12) Patent Application Publication
(10) Pub. No.: US 2016/0144276 A1
(43) Pub. Date: May 26, 2016

(54) INFORMATION PROCESSING DEVICE AND GAME PROGRAM

(71) Applicant: DeNA Co., Ltd., Tokyo (JP)

(72) Inventors: Yuji UKAI, Tokyo (JP); Takahiro OTOMO, Tokyo (JP)

(21) Appl. No.: 14/920,725

(22) Filed: Oct. 22, 2015

(30) Foreign Application Priority Data
Nov. 26, 2014 (JP) 2014-238863

(51) Int. Cl. A63F 13/25

(52) U.S. Cl. CPC A63F 13/25

(57) ABSTRACT

An information processing device is provided with a game content appearance module that determines a game content object, selected from among multiple game content objects based on the appearance probability associated with each one of the multiple game content objects, to be an appearing game content object that appears to a player; an appearance probability variation module that varies the appearance probability, when a specifying operation used to specify a game content object from among the multiple game content objects is performed by the player, so as to increase or decrease the frequency at which the specified game content object is determined to be an appearing game content object; and a parameter configuration module that configures the parameters of the specified game content object depending on whether the frequency of determination of said game content object as an appearing game content object is increased or decreased.

The present application claims the benefit of Japanese Patent Application No. JP2014-238863, filed on Nov. 26, 2014, the content of which is incorporated herein in its entirety by reference.

### BACKGROUND

1. Technical Field

The present invention relates to an information processing device and a game program (e.g., non-transitory computer readable medium having machine-executable instructions with which a computer having a storage and a hardware processor, for providing a service).

2. Related Art

Information processing devices are known in which a particular game content object is chosen from a deck that contains multiple game content objects, based on an appearance probability (probability of winning) configured for each of the game content objects, and said chosen game content object appears and is provided to the player as a won game content object (e.g., see Patent Document 1).

### PRIOR ART DOCUMENT

### Patent Document

### [Patent Document 1]

Japanese Patent Publication No. 5,335,969

### Problems to be Solved by the Invention

Generally speaking, the higher the level and other parameters configured for a game content object, the more players there are who want to obtain that game content object, which is why the probability of its appearance as a won game content object is often set to be low. For this reason, even though the player may want for this game content object to appear, it seldom does. On the other hand, increasing the appearance probability of a game content object whose parameters are set to be high diminishes its rarity value, thereby causing more players to become less enthusiastic about playing the game.

The present invention takes such circumstances into account and is intended to encourage the player to play the game with enthusiasm while striking a balance between the appearance probability and parameters of the game content objects.

### SUMMARY

The main aspect of the present invention intended to eliminate the above-mentioned problems is

an information processing device provided with

a storage module that stores an appearance probability and parameters in association with each one of multiple game content objects;

a game content appearance module that determines a game content object, selected from among the multiple game content objects based on the appearance probability of each game content object, to be an appearing game content object that appears to a player;

an appearance probability variation module that, when a specifying operation used to specify a game content object from among the multiple game content objects is performed by the player, varies the appearance probability so as to increase or decrease the frequency at which the specified game content object is determined to be an appearing game content object; and

a parameter configuration module that configures the parameters of the specified game content object depending on whether the frequency of determination of said game content object as an appearing game content object is increased or decreased.

Other features of the present invention will become apparent from this Specification and the accompanying Drawings.

### BRIEF DESCRIPTION OF THE DRAWINGS

FIG. 1 A diagram illustrating an example configuration of the entire game system 1.

FIG. 2 A block diagram illustrating the functional configuration of the server device 10.

FIG. 3 A diagram illustrating an example data structure of character information.

FIG. 4 A diagram illustrating an example data structure of player information

FIG. 5 A diagram illustrating an example data structure of proprietary character information.

FIG. 6 A diagram illustrating an example data structure of the deck information.

FIG. 7 A block diagram illustrating the functional configuration of the player terminal 20.

FIG. 8 A flow chart used to illustrate an example of operation of the game system 1.

FIG. 9 A diagram illustrating an example deck configuration screen 50.

FIG. 10 A diagram illustrating an example character selection screen 60.

FIG. 11 A diagram illustrating an example adjusted deck configuration screen 70.

FIG. 12A illustrates various information items related to the initial state of enemy characters.

FIG. 12B illustrates various adjusted information items related to enemy characters.

### DETAILED DESCRIPTION

At least the following will be apparent from this Specification and the accompanying Drawings.

Namely, an information processing device provided with

a storage module that stores an appearance probability and parameters in association with each one of multiple game content objects;

a game content appearance module that determines a game content object, selected from among the multiple game content objects based on the appearance probability of each game content object, to be an appearing game content object that appears to a player:

an appearance probability variation module that, when a specifying operation used to specify a game content object from among the multiple game content objects is performed by the player, varies the appearance probability so as to increase or decrease the frequency at which the specified game content object is determined to be an appearing game content object; and

a parameter configuration module that configures the parameters of the specified game content object depending on whether the frequency of determination of said game content object as an appearing game content object is increased or decreased.

Such an information processing device makes it possible to encourage the player to play the game with enthusiasm by striking a balance between the appearance probability and parameters of the game content object specified by the player.

In such an information processing device, the parameter configuration module may be adapted to vary the parameters of the specified game content object to be disadvantageous to the player if the appearance probability is varied such that the frequency of determination of said game content object as an appearing game content object is increased.

Such an information processing device makes it possible to encourage the player to play the game with enthusiasm while striking a balance by making the game content object specified by the player more likely to appear while varying the parameters of said game content object to be disadvantageous to the player.

In such an information processing device, the parameter configuration module may be adapted to vary the parameters of the specified game content object to be advantageous to the player if the appearance probability is varied such that the frequency of determination of said game content object as an appearing game content object is decreased.

Such an information processing device makes it possible to encourage the player to play the game with enthusiasm while striking a balance by making the game content object specified by the player less likely to appear while varying the parameters of said game content object to be advantageous to the player.

In such an information processing device, the appearance probability variation module, in the event that multiple game content objects are specified by the player's specifying operation, may be adapted to respectively vary the appearance probabilities of the specified multiple game content objects, and

the parameter configuration module may be adapted to increasingly vary the parameters of the game content objects as the number of the game content objects whose appearance probabilities are varied by the appearance probability variation module decreases.

Even if the player specifies multiple game content objects, such an information processing device makes it possible to encourage the player to play the game with enthusiasm while striking a balance between the appearance probabilities and parameters of the game content objects specified by the player.

In such an information processing device, the parameter configuration module may be adapted to increasingly vary the parameters of the specified game content object as the variation of the appearance probability of the game content object increases.

Such an information processing device makes it possible to encourage the player to play the game with enthusiasm while striking a balance by mutually adjusting the amount of variation in the appearance probability and parameters of the game content object specified by the player.

In such an information processing device, the appearance probability variation module may be adapted to vary the appearance probability such that, when a specifying operation used to specify a game content object from among the multiple game content objects is performed by the player, the frequency of determination of the specified game content object as an appearing game content object is increased and, at the same time, the frequency at which other unspecified game content objects are determined to be appearing game content objects is decreased, and

the parameter configuration module may be adapted to vary the parameters of the other undesignated game content objects to be advantageous to the player if the appearance probability is varied such that the frequency of determination of the specified game content object as an appearing game content object is increased.

Due to the fact that game content object has configured therein parameters that are varied to be advantageous to the player, such an information processing device allows for the player's disappointment to be alleviated even if a game content object that the player did not specify appears.

In addition, a game program (e.g., non-transitory computer readable medium having machine-executable instructions with which a computer having a storage and a hardware processor, for providing a service) directing a computer to execute

a storage process for storing in a storage module an appearance probability and parameters in association with each one of multiple game content objects;

a game content appearance process for determining a game content object, selected from among the multiple game content objects based on the appearance probability of each game content object, to be an appearing game content object that appears to a player;

an appearance probability variation process for varying the appearance probability, when a specifying operation used to specify a game content object from among the multiple game content objects is performed by the player, so as to increase or decrease the frequency of determination of the specified game content object as an appearing game content object, and

a parameter configuration process for configuring the parameters of the specified game content object depending on whether the frequency of determination of said game content object as an appearing game content object is increased or decreased.

Such a game program makes it possible to encourage the player to play the game with enthusiasm while striking a balance between the appearance probability and parameters of the game content object specified by the player.

### Embodiment 1

### Configuration of Game System 1

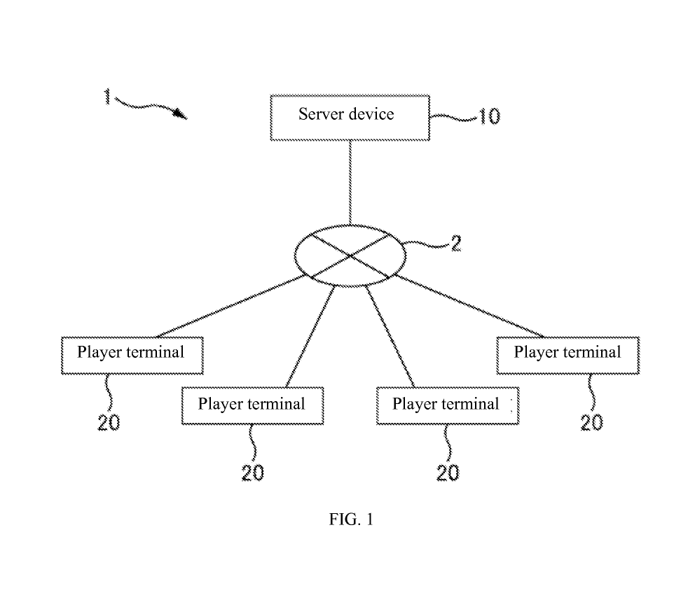

FIG. 1 is a diagram illustrating an example configuration of the entire game system 1. The game system 1 provides various game-related services to the player over a network 2 (for example, the Internet) and includes a server device 10 and multiple player terminals 20.

The game system 1 according to the present embodiment can provide the player with a lottery game whose objective is to acquire character cards (hereinafter referred to simply as “characters”), as an example of game content objects.

When a lottery drawing starts during a lottery game in the present embodiment, a character chosen from a container deck (also referred to simply as “a deck”) containing multiple characters based on the appearance probability (probability of winning) configured for each one of the characters (hereinafter also referred to as an “appearing character”) appears and is provided to the player.

In the initial state, the appearance probability is set to be low for a character whose level is set to be high. For this reason, even though the player may want for the high-level character to appear, it seldom does. Accordingly, in the present embodiment, when the player specifies a desired character, the appearance probability of said character is increased from its initial value to be advantageous to the player. As a result, the character specified by the player becomes more likely to be chosen as an appearing character, regardless of the fact that the character may have originally been a character that seldom appears. Meanwhile, in the present embodiment, although the appearance probability of the character specified by the player is increased, the level of said character is decreased from its initial value to be disadvantageous to the player. For this reason, despite the fact that the character may have originally been a high-level character, a character with a level lower than the original level is chosen as the appearing character. Doing so adjusts the balance between the appearance probability and the level configured for the character.

### <<Configuration of Server Device 10>>

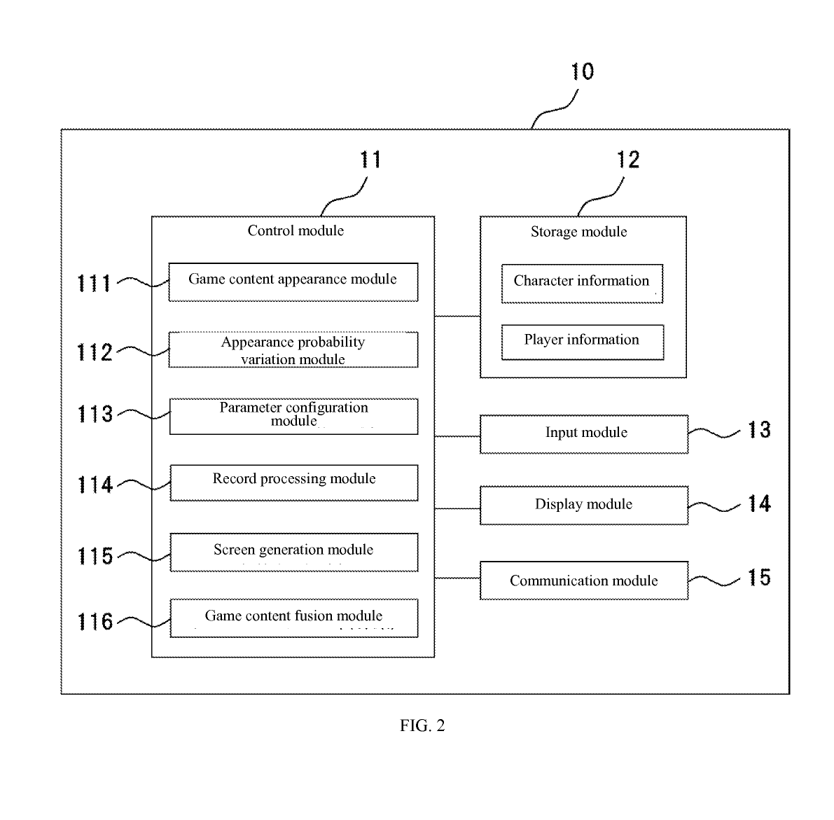

FIG. 2 is a block diagram illustrating the functional configuration of the server device 10. The server device 10 is an information processing device (for example, a workstation, a personal computer, etc.) used by a system administrator to operate and manage a variety of services.

Upon receiving various commands (requests) from player terminals 20, the server device 10 transmits (responds by sending) game programs operational on the player terminals 20 and various types of data and web pages (game screens, etc.) created using a markup language (HTML, etc.) compliant with the specifications of the player terminals 20. The server device 10 has a control module 11, a storage module 12, an input module 13, a display module 14, and a communication module 15.

The control module 11, along with transferring data between the components, exercises overall control over the server device 10, and is implemented using a CPU (Central Processing Unit) that runs a predetermined program stored in memory. The control module 11 of the present embodiment is provided at least with a game content appearance module 111, an appearance probability variation module 112, a parameter configuration module 113, a record processing module 114, a screen data generation module 115, and a game content fusion module 116.

The game content appearance module 111 possesses functionality to carry out processes of various types related to the appearance of game content objects. The game content appearance module 111 of the present embodiment determines a character, selected from among multiple characters based on the appearance probability of each character, to be an appearing character that appears to the player. The player can acquire and own this appearing character.

The appearance probability variation module 112 possesses functionality to carry out processes of various types related to appearance probability variation. The appearance probability variation module 112 of the present embodiment varies the appearance probability so as to increase or decrease the frequency at which a specified character is determined to be an appearing character, when a specifying operation used to specify a character is performed by the player.

The parameter configuration module 113 possesses functionality to carry out processes of various types related to parameter configuration. The parameter configuration module 113 of the present embodiment configures the parameters of the character specified by the player depending on whether the frequency of determination of said character as an appearing character is increased or decreased.

The record processing module 114 possesses functionality to carry out a process whereby data of various types is written to a storage area in the storage module 12. For example, the record processing module 114 of the present embodiment records the appearance probabilities, as well as levels and other parameters, in association with each one of the multiple characters in the storage module 12.

The screen data generation module 115 possesses functionality to carry out a process that generates screen data used for displaying a game screen on the player terminals 20. The screen data generation module 115 of the present embodiment generates HTML data as the screen data corresponding to the game screen.

The game content fusion module 116 possesses functionality to carry out processes of various types related to character fusion. The game content fusion module 116 of the present embodiment fuses a character specified by the player (base character) with another character (source material character), thereby making it possible to increase the level and other parameters configured in the base character or evolve it into a new base character with a different character ID. It should be noted that base characters have at least one or more source material characters pre-associated therewith, and it is necessary to fuse the base characters with these associated source material characters in order to evolve the base characters. The number, rarity, level and other parameters of the associated source material characters are then pre-configured according to the type of the base character. In addition, the base characters are configured to have levels used for evolution through character fusion, and it is necessary to raise the base characters to these levels in order to evolve the base characters.

The storage module 12 has a ROM (Read Only Memory), which is a read-only storage area where operating system software is stored, and a RAM (Random Access Memory), which is a rewritable storage area used as a work area for arithmetic processing by the control module 11, and is implemented as a non-volatile storage device, such as a flash memory, a hard disk, or the like. The storage module 12 of the present embodiment stores at lease character information and player information. This information will be described in more detail below.

The input module 13 is used by a system administrator for input of game service-related data of various types (e.g., character information and so forth) and is implemented, for example, using a keyboard, a mouse, or the like.

The display module 14, which is used for displaying operation screens used by the system administrator in response to commands from the control module 11, is implemented using a liquid crystal display (LCD: Liquid Crystal Display), or the like.

The communication module 15, which is used for communication with the player terminals 20, has receiver functionality for receiving various types of data and signals transmitted from the player terminals 20 and transmitter functionality for transmitting various types of data and signals to the player terminals 20 in response to commands from the control module 11. The communication module 15 is implemented, for example, as an NIC (Network Interface Card), or the like.

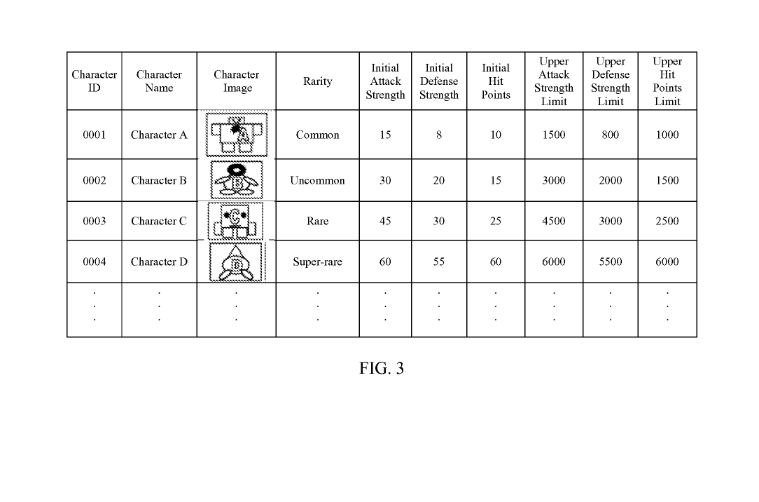

FIG. 3 is a diagram illustrating an example data structure of the character information. The character information has configured therein, in association with character IDs, at least a character name, a character image, rarity, initial attack strength, initial defense strength, initial hit points, maximum attack strength, maximum defense strength, and maximum hit points. Thus, in the present embodiment, the initial values and upper limit values of the capability parameters are configured for each character.

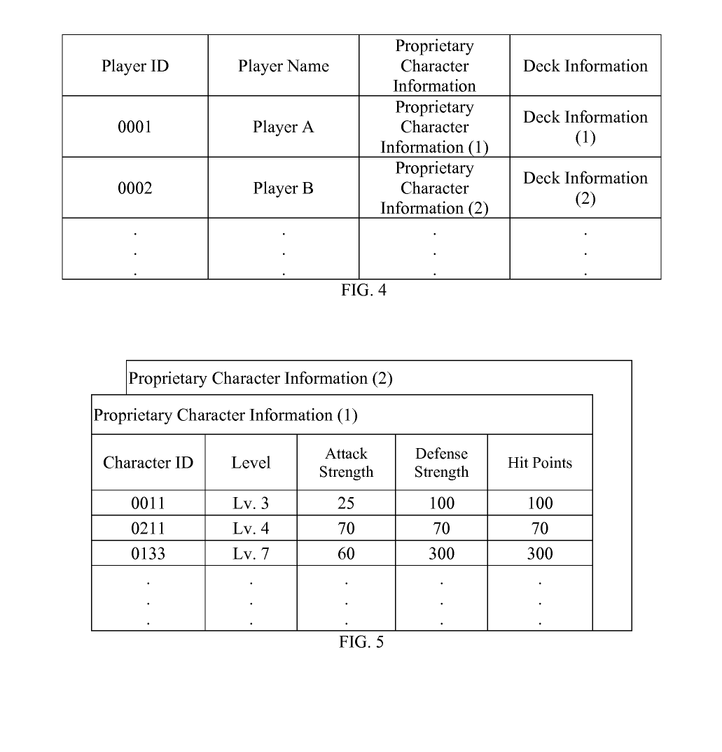

FIG. 4 is a diagram illustrating an example data structure of the player information. This player information has configured therein, in association with player IDs, at least player names, proprietary character information, and deck information.

FIG. 5 is a diagram illustrating an example data structure of the proprietary character information. The proprietary character information represents information relating to the characters belonging to the players (hereinafter referred to as “proprietary characters”). This proprietary character information has configured therein, in association with the character IDs of the proprietary characters, at least the current level and current attack strength, defense strength, and hit points.

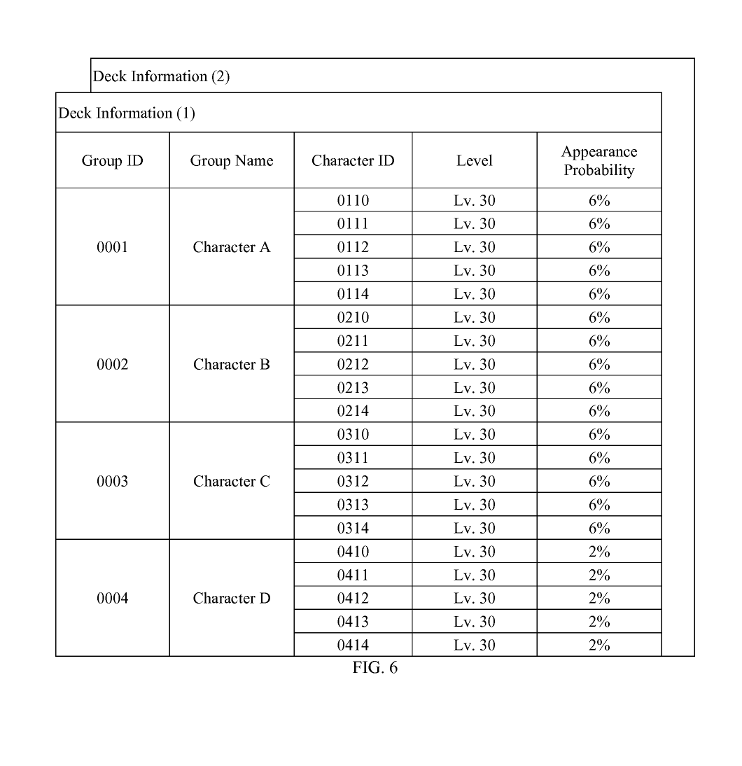

FIG. 6 is a diagram illustrating an example data structure of the deck information. The deck information represents information that defines a container deck, in which a predetermined number of characters that can be provided to the player are combined in a single set. This deck information has configured therein, in association with group IDs, at least the name of the group, as well as the character IDs, levels, and the appearance probabilities of the characters belonging to that group. In this manner, according to the present embodiment, multiple characters are configured in each group. In addition, they are configured such that the sum total of the appearance probabilities of the characters amounts to 100%.

### <<Configuration of Player Terminal 20>>

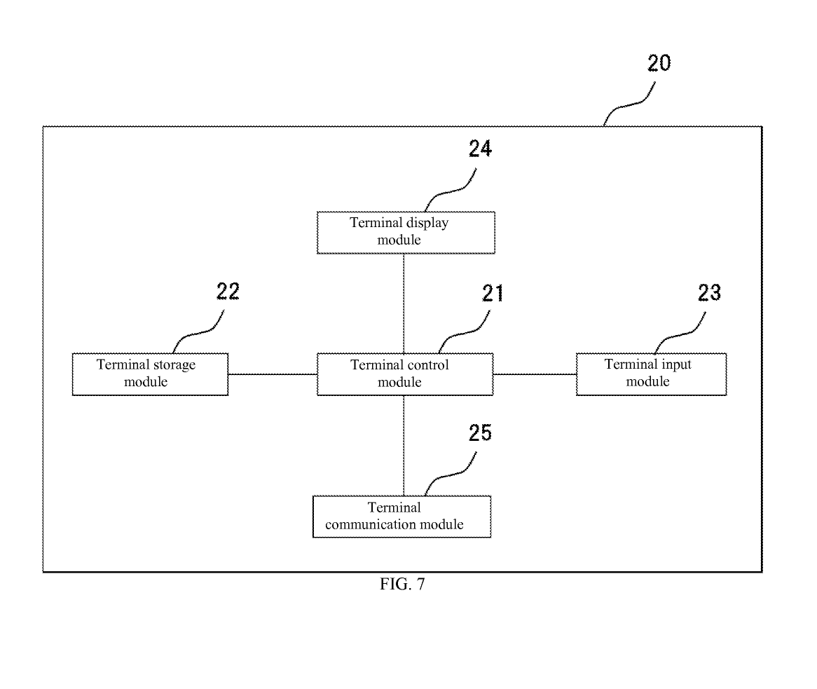

FIG. 7 is a block diagram illustrating the functional configuration of a player terminal 20. The player terminals 20 are information processing devices owned and used by the players (e.g., tablet terminals, mobile phone terminals, smartphones, and the like). Due to the web browser functionality they possess, the player terminals 20 are capable of on-screen display of web pages (game screens, and the like) transmitted from the server device 10. A player terminal 20 has a terminal control module 21 used for overall control of the player terminal 20, a terminal storage module 22 used for storing various types of data and programs, a terminal input module 23 used by the player for operation input, a terminal display module 24 used for displaying game screens and operation screens, and a terminal communication module 25 used for communicating information to and from the server device 10.

### <<Regarding Operation of Game System 1>>

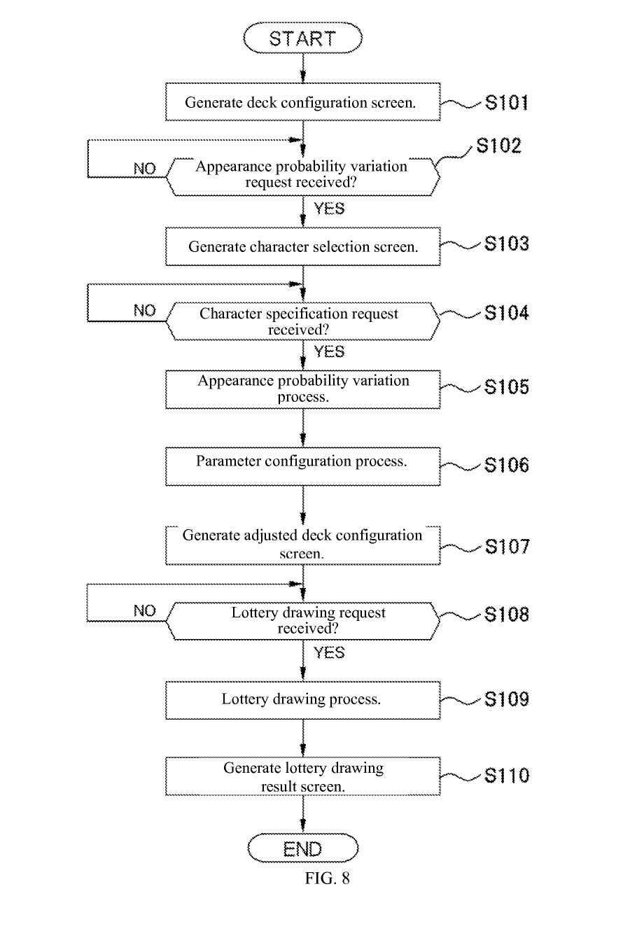

FIG. 8 is a flow chart used to illustrate an example of operation of the game system 1 of the present embodiment. An example of operation of the lottery game of the present embodiment is explained in specific detail below.

First, the server device 10 responds to a screen transmission request from a player terminal 20 and directs the screen generation module 115 to generate screen data used to display a game screen on the player terminal 20 (Step S101).

Specifically, the screen generation module 115 acquires the player ID configured in the received screen transmission request and refers to the player information shown in FIG. 4 and the deck information shown in FIG. 6. etc. to generate screen data for a deck configuration screen that shows the configuration of the deck allocated to the player.

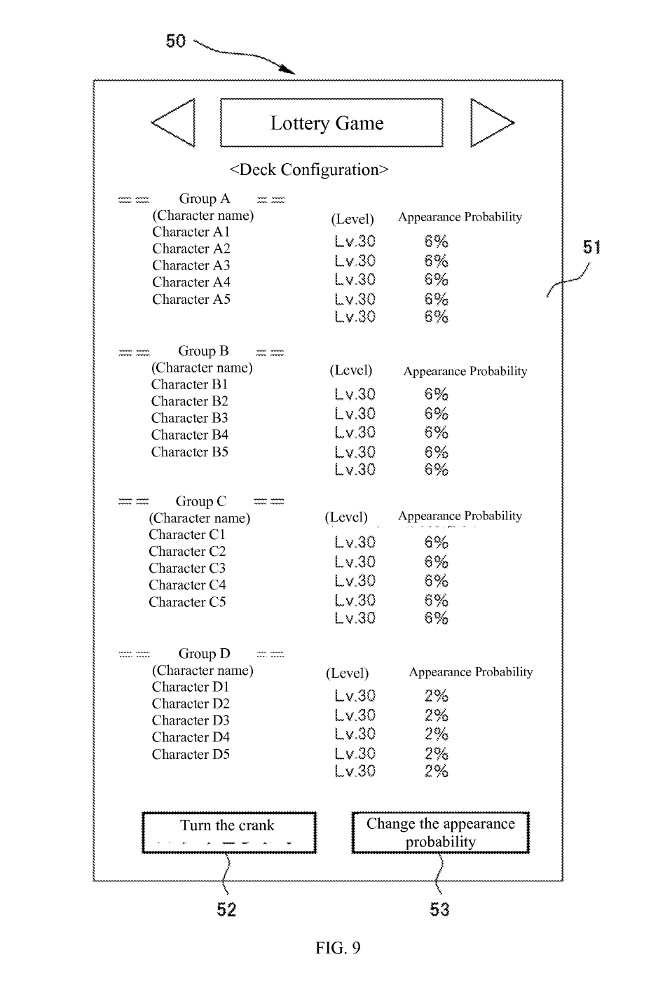

The server device 10 transmits the thus generated screen data to the requesting player terminal 20 over a network 2. Subsequently, upon receipt of the screen data transmitted from the server device 10, the player terminal 20 analyzes the screen data and, as a result, displays the deck configuration screen 50 shown in FIG. 9 on the terminal display module 24.

FIG. 9 is a diagram illustrating an example deck configuration screen 50. This deck configuration screen 50 includes a deck configuration display area 51, a control button 52, and a control button 53. The characters that comprise the deck are combined into groups and displayed in the deck configuration display area 51. Each character has its respective level and appearance probability displayed in association therewith. The control button 52 is a control area in which the player performs operations to initiate a lottery drawing. The control button 53 is a control area in which the player performs operations to change the character's appearance probability.

If the control button 52 is selected by the player's selection operation while this deck configuration screen 50 is displayed on the terminal display module 24, the player terminal 20 transmits a command including a request to start a lottery drawing (lottery drawing request) to the server device 10. On the other hand, if the control button 53 is selected by the player's selection operation, the player terminal 20 transmits a command including a request to vary the appearance probability (appearance probability variation request) to the server device 10.

Next, the server device 10 determines whether or not an appearance probability variation request has been transmitted from the player terminal (Step S102). If said determination is negative (Step S102: NO), standby mode is maintained until the appearance probability variation request arrives from the player terminal 20. On the other hand, if said determination is positive (Step S102: YES), the process advances to Step S103.

Next, upon receipt of the appearance probability variation request transmitted from the player terminal 20, the server device 10 directs the screen generation module 115 to generate screen data for displaying a selection screen used to select groups or characters on the player terminal 20 (Step S103).

Specifically, the screen generation module 115 refers to the character information shown in FIG. 3 and the deck information shown in FIG. 6 to extract the characters and groups making up the deck allocated to the player and generate screen data corresponding to a character selection screen.

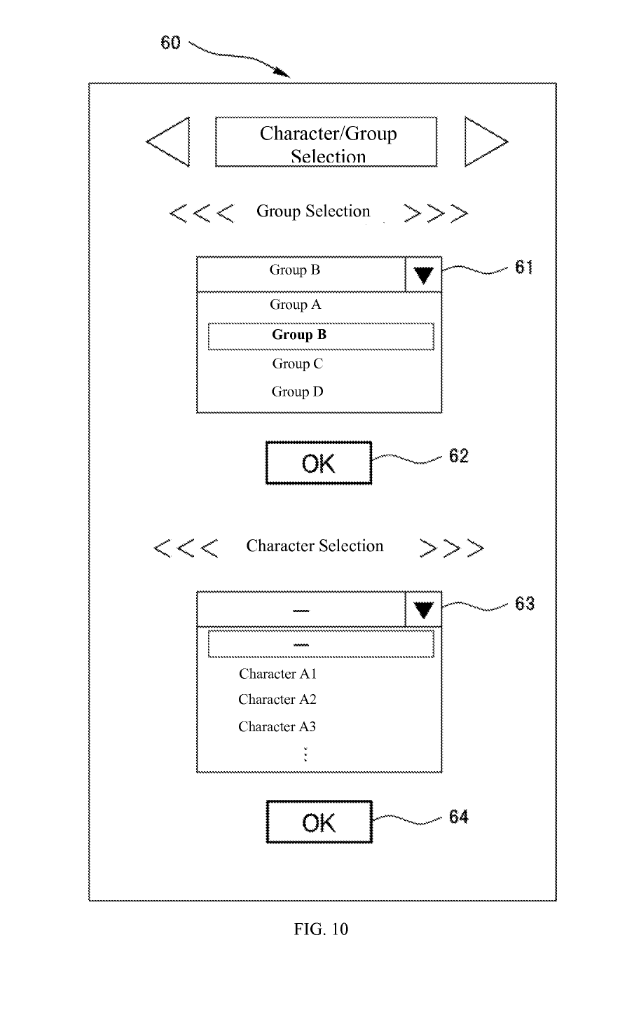

The server device 10 transmits the thus generated screen data to the requesting player terminal 20 over the network 2. Subsequently, upon receipt of the screen data transmitted from the server device 10, the player terminal 20 analyzes this screen data and, as a result, the character selection screen 60 shown in FIG. 10 is displayed on the terminal display module 24.

FIG. 10 is a diagram illustrating an example character selection screen 60. This character selection screen 60 includes a pull-down menu 61, a control button 62, a pull-down menu 63, and a control button 64. The pull-down menu 61 is a control area that allows the player to specify groups containing multiple characters whose appearance probabilities are varied. If the player performs a selection operation using the pull-down menu 61, multiple characters are specified at once. The control button 62 is a control area used for the confirmation of the groups specified by the selection operations performed using the pulldown menu 61. The pull-down menu 63 is a control area that allows the player to specify individual characters whose appearance probabilities are varied. If the player performs a selection operation using the pull-down menu 63, the characters in the group are specified on an individual basis. The control button 64 is a control area used for the confirmation of the characters specified by the selection operations performed using the pulldown menu 63.

While this character selection screen 60 is displayed on the terminal display module 24, the player operates the pull-down menu 61 or the pull-down menu 63 to specify a group or a character whose appearance probability is varied, whereupon the control button 62 or the control button 64 is selected by the player and a command containing a request to specify a group or a character (character specification request) based on such operational information is transmitted by the player terminal 20 to the server device 10.

Next, the server device 10 determines whether or not a character specification request has been transmitted from the player terminal (Step S104). If said determination is negative (Step S104: NO), standby mode is maintained until the group or character specification request arrives from the player terminal 20. On the other hand, if said determination is positive (Step S104: YES), the process advances to Step S105.

Next, if a character specification request transmitted from the player terminal 20 has been received, the server device 10 carries out an appearance probability variation process (Step S105). Specifically, the appearance probability variation module 112 varies the appearance probability so as to increase the frequency at which the character specified by the player is chosen as an appearing character. In other words, if a particular group has been specified by the player on the selection screen 60 illustrated in FIG. 10, the appearance probability variation module 112 increases the respective appearance probability of each character in that group. In addition, if a particular character has been specified by the player on the selection screen 60 illustrated in FIG. 10, the appearance probability variation module 112 increases the appearance probability of that individual character. Accordingly, the character desired by the player becomes more likely to be chosen as an appearing character as a result of the lottery game. In addition, along with increasing the character's appearance probability in this manner, the appearance probability variation module 112 decreases the appearance probability of other characters that have not been specified by the player. By doing so, the sum total of the appearance probabilities of the characters contained in the deck is adjusted to 100%. It should be noted that, at such time, the appearance probability variation module 112 updates the player's deck information (see FIG. 6) so as to configure the adjusted appearance probabilities.

Next, the server device 10 carries out a parameter configuration process (Step S106). Specifically, the parameter configuration module 113 configures the parameters of the character specified by the player depending on whether or not the frequency at which said character is chosen as an appearing character is increased. In the present embodiment, along with increasing the appearance probability of the character specified by the player, the parameter configuration module 113 decreases the level of said character to be disadvantageous to the player.

Accordingly, although the character sought by the player becomes more likely to be chosen as a result of a lottery drawing, the character that is chosen will have a level lower than its original level. By contrast, along with decreasing the appearance probability of other characters that have not been specified by the player, the parameter configuration module 113 increases the level of said other characters to be advantageous to the player. By doing so, the lottery drawing results in choosing a character with a level higher than the original level even if a character that the player does not want is chosen as the appearing character. For this reason, the player's disappointment can be alleviated even if the character sought by the player does not appear. It should be noted that at such time the parameter configuration module 113 updates the player's deck information (see FIG. 6) so as to configure adjusted levels.

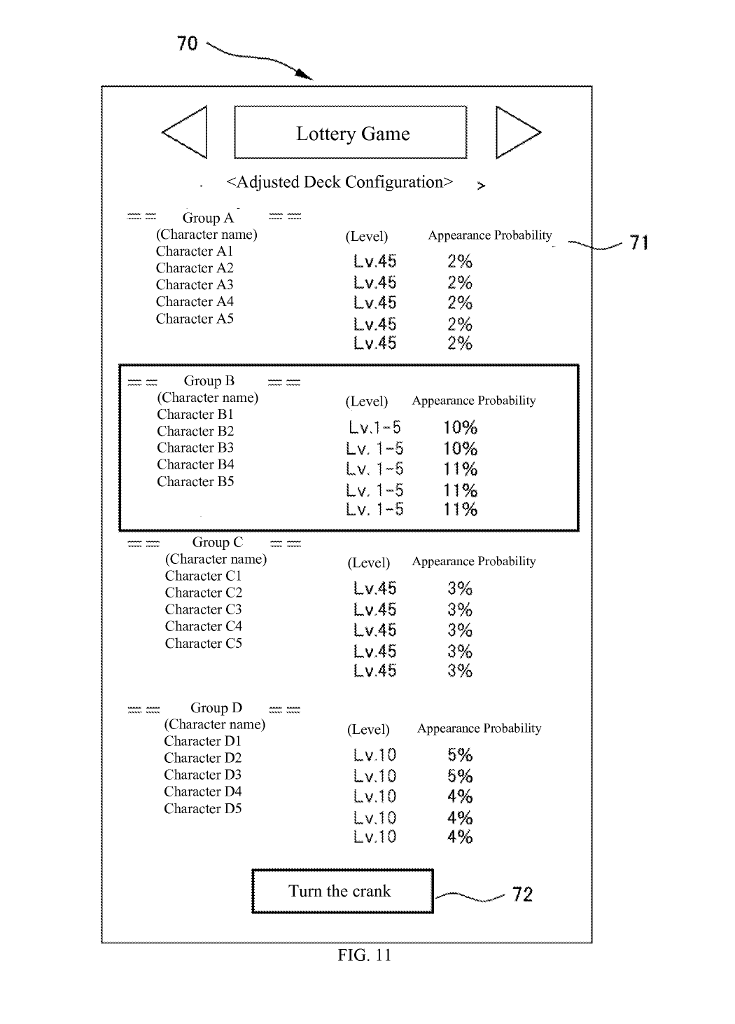

Next, based on the results of carrying out the appearance probability variation process and the parameter configuration process in this manner, the server device 10 directs the screen generation module 115 to generate screen data used to display an adjusted deck configuration screen on the player terminal 20 (Step S107). The server device 10 then transmits the thus generated screen data to the requesting player terminal 20 over the network 2. After that, upon receipt of the screen data transmitted from the server device 10, the player terminal 20 analyzes the screen data and, as a result, displays the adjusted deck configuration screen 70 shown in FIG. 11 on the terminal display module 24.

FIG. 11 is a diagram illustrating an example of the adjusted deck configuration screen 70. Here, explanations are given with reference to a case in which the player specifies “Group B” on the character selection screen 60 illustrated in FIG. 10. This deck configuration screen 70 includes an adjusted deck configuration display area 71 and a control button 72. Because the player has specified “Group B” in the adjusted deck configuration display area 71, information related to the characters that comprise “Group B” is displayed enclosed in a bold-line frame. The control button 72 is an area in which the player performs operations to initiate a lottery drawing.

Here, a comparison with “Group B” shown on the deck configuration screen 50 illustrated in FIG. 9 can confirm that, on the adjusted deck configuration screen 70 illustrated in FIG. 11, although the appearance probability of the characters that comprise “Group B” has been increased, their levels have been decreased. Thus, the character the player wants to acquire becomes more likely to be chosen as a result of a lottery drawing, but even if the player does acquire the character, the acquired character will have a level that is lower than its original level, which is disadvantageous to the player. However, if the character can be raised to the original level by cultivating through repeated character fusion, for example, for a period of time after its acquisition, then the result will be the same as acquiring the desired character with the original high level configured therein.

By contrast, a comparison with “Group A” and “Group C” shown on the deck configuration screen 50 illustrated in FIG. 9 can confirm that, on the adjusted deck configuration screen 70 illustrated in FIG. 11, although the appearance probabilities of the characters that comprise “Group A” and “Group C”, which the player has not specified, have been decreased, their levels have been increased. Thus, a character that the player does not want to acquire is less likely to be chosen as a result of a lottery drawing, but if the player does acquire the character, the acquired character will have a level that is higher than its original level, which is advantageous to the player.

In addition, a comparison with “Group D” shown on the deck configuration screen 50 illustrated in FIG. 9 can confirm that, on the adjusted deck configuration screen 70 illustrated in FIG. 11, although the appearance probabilities of the characters that comprise “Group D”, which the player has not specified, have been increased, their levels have been decreased. Thus, just like the specified “Group B”, a group (character) that has not been specified by the player may be more likely to be chosen as a result of a lottery drawing. This is due to the fact that the sum total of the appearance probabilities of the characters contained in the deck has to be adjusted to 100%.

If the control button 72 is selected by the player's selection operation while this adjusted deck configuration screen 70 is displayed on the terminal display module 24, the player terminal 20 transmits a command including a request to start a lottery drawing (lottery drawing request) to the server device 10.

Next, the server device 10 determines whether or not a lottery drawing request has been transmitted from the player terminal (Step S108). If said determination is negative (Step S108: NO), standby mode is maintained until the lottery drawing request arrives from the player terminal 20. On the other hand, if said determination is positive (Step S108: YES), the process advances to Step S109.

Next, upon receipt of the lottery drawing request transmitted from the player terminal 20, the server device 10 carries out a lottery drawing process (Step S109). Specifically, the game content appearance module 111 refers to the deck information illustrated in FIG. 6 to choose a particular game content object from the multiple characters that comprise the deck allocated to the player based on the appearance probability configured for each character, and determines said chosen character as an appearing character. At such time, the game content appearance module 111 updates the player's proprietary character information (see FIG. 5) such that the character determined to be an appearing character as a result of the lottery drawing becomes a proprietary character of the player.

Next, when the character chosen in this manner as a result of the lottery drawing process is provided to the player, the server device 10 directs the screen generation module 115 to generate screen data used to display a lottery drawing result screen on the player terminal 20 (Step S110). The server device 10 then transmits the thus generated screen data to the requesting player terminal 20 over the network 2. Subsequently, upon receipt of the screen data transmitted from the server device 10, the player terminal 20 analyzes the screen data and, as a result, a lottery drawing result screen is displayed on the terminal display module 24.

As described above, the game system 1 of the present embodiment strikes a balance by making the character specified by the player during a lottery game more likely to appear while decreasing the level of said character below the original level, and this makes it possible to encourage the player to play the game with enthusiasm.

### Embodiment 2

### Regarding the Configuration of Game System 1

The game system 1 according to Embodiment 2 has the same system configuration as the game system 1 according to the above-described Embodiment 1. In addition, the server device 10 and the player terminals 20 also have the same configuration.

The game system 1 according to the present embodiment can provide the player with a battle game conducted in the form of duels between paired character cards (hereinafter referred to simply as “characters”), as an example of game content objects.

In the battle game of the present embodiment, a particular character is chosen from multiple characters based on the appearance probability configured for each character, said chosen character is determined to be an appearing character, and is made to appear and disappear on a battle stage (e.g., in a dungeon). The appearing character chosen in this manner is configured as an enemy character representing the player's opponent.

However, even though the player may want a high-rarity character to appear, such a character seldom does because the appearance probability is set to be low. For this reason, in the present embodiment, when the player specifies a desired character, the appearance probability variation module 112 increases the appearance probability of said character from its initial value to be advantageous to the player. On the other hand, the parameter configuration module 113 increases the hit point parameter of said character from its initial value to be disadvantageous to the player.

### <Regarding the Appearance Probability and Parameters of Enemy Characters>

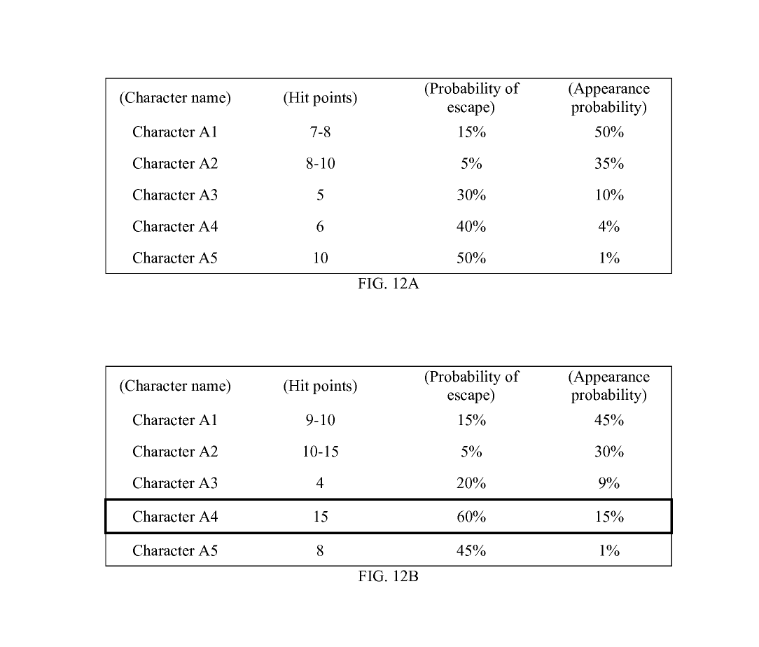

FIG. 12 is a diagram illustrating various information items configured for enemy characters. FIG. 12A illustrates various information items in the initial state of enemy characters. FIG. 12B illustrates various adjusted information items relating to enemy characters. Here, five enemy characters are configured as characters that can appear on, and disappear from a battle stage, with the sum total of the appearance probabilities of the characters being configured to amount to 100%. The explanation will be discussed for a case in which “Character A4” is specified by the player from among the five enemy characters.

A comparison between FIG. 12A and FIG. 12B can confirm that the appearance probability of “Character A4” has been increased and, at the same time, the hit point parameter and the probability of escape have also been increased. In this manner, although the enemy character sought by the player becomes more likely to appear and, even if the player were to engage in combat with this enemy character, this would mean engaging in combat with an enemy character whose hit point parameter is higher than its original level and who is able to escape more easily, which would make this opponent less likely to be defeated and would thus be disadvantageous to the player.

By contrast, in the case of “Character A5”, which has not been specified by the player, it can be confirmed that while the appearance probability has not changed, the hit point parameter and the probability of escape have been decreased. Thus, if an enemy character that the player does not want were to appear, this would mean engaging in combat with an enemy character whose hit point parameter is lower than its original level and who is unable to escape as easily, which would be advantageous to the player.

As described above, the game system 1 according to the present embodiment strikes a balance by making the enemy character specified by the player during a battle game more likely to appear and while increasing the hit point parameter and escape probability of said character in excess of the original level, and this makes it possible to encourage the player to play the game with enthusiasm.

### Other Embodiments

The foregoing embodiment was intended to facilitate the understanding of the present invention and is not to be construed as limiting of the present invention. The present invention can be modified and improved without departing from its spirit and the present invention includes equivalents thereto. In particular, the embodiments described below are also included in the present invention.

### <Specification of Characters>

Although the present embodiment described above has been discussed with reference to a case in which the appearance probability of a character specified by the player during a lottery game is increased while the level of said character is decreased so as to be disadvantageous to the player, the present invention is not limited thereto. For example, the appearance probability of the character specified by the player may be decreased and, on the other hand, the level of said character may be increased so as to be advantageous to the player. Accordingly, specifying a character that the player does not want to acquire can make this character less likely to appear.

In addition, although the present embodiment described above has been discussed with reference to a case in which, along with increasing the appearance probability of an enemy character specified by the player during a battle game, the hit point parameter and probability of escape of said enemy character are increased in excess of the original level so as to be disadvantageous to the player, the present invention is not limited thereto. For example, along with decreasing the appearance probability of an enemy character specified by the player, the hit point parameter and probability of escape of said enemy character may be decreased below the original level so to be advantageous to the player. Accordingly, specifying an enemy character that the player does not want to encounter can make this enemy character less likely to appear.

### <Parameter Variation>

In the present embodiment described above, the smaller the number of characters whose appearance probabilities are subject to variation, the greater the variation that the parameters of said characters may undergo. For example, when the player specifies a single character in a group during a lottery game, the number of characters whose appearance probabilities are increased is smaller than when a single group is specified (when 5 characters are specified). At such time, the level of this single character may be decreased well below the level of each of the 5 characters. In addition, when the player specifies a single enemy character in a group during a battle game, the number of enemy characters whose appearance probabilities are increased is smaller than when a single group is specified (when 5 enemy characters are specified). At such time, the hit point parameter of the single enemy character may be increased well in excess of each of the 5 enemy characters. Thus, it is possible to make specifying multiple characters advantageous to the player.

Also, in the present embodiment described above, the greater the variation in the appearance probability of the character specified by the player, the greater the variation that the parameters of said character may undergo. For example, the larger the amount of increase in the appearance probability of a character specified by the player during a lottery game, the larger the amount of the decrease in the level of said character might be. In addition, the larger the amount of increase in the appearance probability of an enemy character specified by the player during a battle game, the larger the amount of increase in the hit point parameter of said enemy character might be. This approach makes it possible to achieve improved balance.

In addition, while the present embodiment described above has been discussed with reference to a case in which the appearance probability of a character specified by the player is increased while the parameters of said character are varied to be disadvantageous to the player, the present invention is not limited thereto. For example, the appearance probability of the character specified by the player may be increased while the evolution of said character may be configured to be inhibited when character fusion is performed.

Specifically, if the player obtains a character whose appearance probability has been increased (e.g., as a result of a lottery game), then the level of the necessary source material characters and the level of said character required to evolve said character through character fusion may be set to be high by the parameter configuration module 113. Alternatively, the game content fusion module 116 may increase the number of the source material characters necessary for the evolution of said character or turn the source material characters necessary for the evolution of said character into high-rarity characters.

### <Game Content>

Although the present embodiment described above has been discussed with reference to character cards, the present invention is not limited thereto. For example, the game content objects may be represented by electronic game data, the characters themselves, figures, and items such as tools and abilities used in the game, and so on.

### <Server Device>

In the present embodiments as described above, the explanations are given with reference to a game system 1 equipped with a single server device 10 as an example of a service device. The invention, however, is not limited thereto and a game system 1 equipped with multiple server devices 10, as an example of server devices, may also be used. In other words, multiple server devices 10 may be connected over a network 2 and these server devices 10 may perform various types of processing in a distributed manner. It should be noted that the service device 10 is an example of a computer.

### <Information Processing Device>

In the game system 1 used in the present embodiment as described above, the explanations are given with reference to a case in which various types of information processing are carried out by directing the server device 10 and the player terminals 20 to cooperate based on a game program (e.g., non-transitory computer readable medium having machine-executable instructions with which a computer having a storage and a hardware processor, for providing a service). The invention, however, is not limited thereto and the above-mentioned various types of information processing may be carried out based on the game program using the server device 10 alone or the player terminals 20 alone as information processing devices.

In addition, a configuration may be used in which the player terminals 20 support part of the information processing device functionality. In such a case, the server device 10 and player terminals 20 constitute an information processing device. It should be noted that the information processing device is an example of a computer equipped with a processor and a memory.

### DESCRIPTION OF REFERENCE NUMERALS

1 Game system
2 Network
10 Server device
11 Control module
12 Storage module
13 Input module
14 Display module
15 Communication module
20 Player terminal
21 Terminal control module
22 Terminal storage module
23 Terminal input module
24 Terminal display module
25 Terminal communication module
50 Deck configuration screen
51 Deck configuration display area
52 Control button
53 Control button
60 Character selection screen
61 Pull-down menu
62 Control button
63 Pull-down menu
64 Control button
70 Deck configuration screen
71 Deck configuration display area
72 Control button
111 Game content appearance module
112 Appearance probability variation module
113 Parameter configuration module
114 Record processing module
115 Screen generation module
116 Game content fusion module

1. An information processing device provided with
a storage module that stores an appearance probability and parameters in association with each one of multiple game content objects;
a game content appearance module that determines a game content object, selected from among the multiple game content objects based on the appearance probability of each game content object, to be an appearing game content object that appears to a player;
an appearance probability variation module that, when a specifying operation used to specify a game content object from among the multiple game content objects is performed by the player, varies the appearance probability so as to increase or decrease the frequency at which the specified game content object is determined to be an appearing game content object;
a parameter configuration module that varies the parameters of the specified game content object to be disadvantageous to the player if the appearance probability is varied such that the frequency of determination of said game content object as an appearing game content object is increased; and
a game content fusion module that, upon acquisition of said appearing game content object by the player as a result of determination by the game content appearance module that the game content object having configured therein parameters varied to be disadvantageous to the player by the parameter configuration module based on the appearance probability varied by the appearance probability variation module so as to increase the frequency of its determination as an appearing game content object is an appearing game content object that appears to the player, fuses said acquired game content object with another game content object to thereby vary the parameters of said game content object to be advantageous to the player.

2. The information processing device according to claim 1, wherein
the parameter configuration module varies the parameters of the specified game content object to be advantageous to the player if the appearance probability is varied such that the frequency of determination of said game content object as an appearing game content object is decreased.

3. The information processing device according to claim 1, wherein
the appearance probability variation module, in the event that multiple game content objects are specified by the player's specifying operation, respectively varies the appearance probabilities of the specified multiple game content objects, and
the parameter configuration module increasingly varies the parameters of the game content objects as the number of the game content objects whose appearance probabilities are varied by the appearance probability variation module decreases.

4. The information processing device according to any of claim 1, wherein
the parameter configuration module increasingly varies the parameters of the specified game content object as the variation of the appearance probability of the game content object increases.

5. The information processing device according to any of claim 1, wherein
the appearance probability variation module varies the appearance probability such that, when a specifying operation used to specify a game content object from among the multiple game content objects is performed by the player, the frequency of determination of the specified game content object as an appearing game content object is increased and, at the same time, the frequency at which other unspecified game content objects are determined to be appearing game content objects is decreased, and
the parameter configuration module varies the parameters of the other unspecified game content objects to be advantageous to the player if the appearance probability is varied such that the frequency of determination of the specified game content object as an appearing game content object is increased.

6. A non-transitory computer readable medium having machine-executable instructions with which a computer having a storage and a hardware processor, for providing a service, said machine-executable instructions comprising:
a storage process for storing in a storage module an appearance probability and parameters in association with each one of multiple game content objects;
a game content appearance process for determining a game content object, selected from among the multiple game content objects based on the appearance probability of each game content object, to be an appearing game content object that appears to a player;
an appearance probability variation process for varying the appearance probability, when a specifying operation used to specify a game content object from among the multiple game content objects is performed by the player, so as to increase or decrease the frequency of determination of the specified game content object as an appearing game content object;
a parameter configuration process for varying the parameters of the specified game content object to be disadvantageous to the player if the appearance probability is varied so as to increase the frequency of determination of said game content object as an appearing game content object; and
a game content fusion process in which, upon acquisition of said appearing game content object by the player as a result of determination by the game content appearance process that the game content object having configured therein parameters varied to be disadvantageous to the player by the parameter configuration process based on the appearance probability varied by the appearance probability variation process so as to increase the frequency of its determination as an appearing game content object is an appearing game content object that appears to the player, said acquired game content object is fused with another game content object to thereby vary the parameters of said game content object to be advantageous to the player.
